(19) United States
(12) Patent Application Publication
(10) Pub. No.: US 2005/0177843 A1
(43) Pub. Date: Aug. 11, 2005

(54) Apparatus for vending and delivering telephone services

(76) Inventor: L. Lloyd Williams, Kanata (CA)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/625,326

(22) Filed: Jul. 23, 2003

Related U.S. Application Data
(62) Division of application No. 10/036,998, filed on Dec. 21, 2001.

(51) Int. Cl. H04N 7/16; H04M 11/00; H04M 15/00

(52) U.S. Cl. 725/23; 379/100.08; 379/114.1

(57) ABSTRACT

An apparatus for providing electronically mailable call credits and call connections to be charged thereto is purchased by a customer for a recipient through the Internet and sent via email to the recipient. The recipient requests a call by activating an icon associated with the email. An application server receives the request and sends a call request message via the Internet to a virtual switching point associated with a switched telephone network. The virtual switching point initiates actions in the switched telephone network to set up a telephone communication between the recipient and a party to be called.

### TECHNICAL FIELD

The invention relates generally to purchasing and charging for connections in a telecommunications network and, in particular, to a method and apparatus for purchasing and delivering telephone services wherein electronic call credits may be purchased by a customer and delivered to a recipient by electronic mail.

### BACKGROUND OF THE INVENTION

In modern telephone networks, it is possible to maintain customer specific accounts into which customers deposit funds to obtain pre-paid call time. When the customer makes a call, the system deducts funds from the account balance on the basis of the connection time used. One system of this type is disclosed in U.S. Pat. No. 5,408,519 entitled TELECOMMUNICATIONS SYSTEM HAVING A LOCAL AREA NETWORK WITH CONCURRENTLY PROCESSING NODES, which issued to Pierce et al. on Apr. 18, 1995. Another system of this type is disclosed in PCT application no. WO/98/27715 entitled A METHOD FOR CONTROLLING A CREDIT CUSTOMER CALL to Kangas et al., which was published on Jun. 25, 1998. Kangas et al. teach that call credits can be purchased by a customer as a gift certificate for presentation to another person.

U.S. Pat. No. 5,442,567 issued to Small on Aug. 15, 1995 and is entitled APPARATUS AND METHOD FOR ELECTRONICALLY DISPENSING PERSONALIZED GREETING CARDS AND GIFTS. Small discloses a vending machine that permits a customer to design and personalize a greeting card. It also permits the customer to integrate an electronically vendible gift with the card. A method of redeeming the gift is disclosed. The customer is presented with a menu and prompted to select a card date from the menu and add personal information via a data input means. A menu of pre-paid long distance telephone access accounts and account values from which a customer can select a particular pre-paid telephone access account of a predetermined value may also be selected. All options selected are printed on the card and the printed card is presented to a recipient. However, no mechanism is provided for delivering the card to the recipient. Consequently, the card must be delivered to the recipient by hand or by mail.

It is therefore desirable to provide a service whereby call credits can be purchased through the Internet and integrated into an electronic personalized gift certificate that may be sent to a recipient via email. It is also desirable to provide a system that permits the initiation of a telephone call to be charged to the credits in a very simple, convenient manner.

### SUMMARY OF THE INVENTION

It is an object of the invention to provide a system that, permits call credits to be purchased electronically.

The invention provides a system that permits call credits to be sent via email to a recipient designated by a buyer.

The invention also provides a method and apparatus that enable a call to be charged to the electronic call credits and to be initiated directly from an electronic call credit certificate that is emailed to the recipient.

The invention further provides a system for enabling the electronic purchase and billing for pre-paid connections in a telecommunications network.

The invention provides a method, system and apparatus for vending call credits through electronic commerce in the form of electronic certificates that are emailed to a designated recipient. On receipt of an electronic certificate, the recipient can initiate a call to be charged to the pre-paid call credits simply by “clicking” on the electronic certificate using a pointing device. The electronic certificate can be repeatedly used until the call credits are exhausted.

Calls initiated from an electronic certificate are set up and monitored by the call control node, which is a virtual switching node in a switched telephone network. The call control node receives call setup instructions from an application server connected to a data network, such as the World Wide Web, through which the electronic certificate was purchased.

According to one aspect of the invention, there is provided a method for providing electronically mailable pre-paid call credits, comprising:

receiving from a customer at an application server via a data network, a purchase order of a specified purchase value for the pre-paid call credits;

collecting and verifying payment data to collect payment for the purchase value;

issuing at the application server an electronic certificate for the purchase value of the call credits, the electronic certificate including information respecting at least the purchase value, a unique identifier for identifying the purchase order and an email address of a recipient of the call credits designated by the customer in the purchase order;

storing the information in a database; and

sending a copy of the electronic certificate to the recipient via email using the email address.

The electronic certificate preferably includes an icon that may be activated to establish calls to be charged against the call credits associated with the electronic certificate.

The electronic certificate is preferably associated with a message from the customer to the recipient if the recipient is not the customer. The electronic certificate may optionally be associated with an electronic greeting card.

The method preferably further comprises the steps of:

receiving at the application server a call request as a result of an action by the recipient who activates the icon, the call request including the unique identifier, a calling telephone number, an Internet Protocol (IP) address of the recipient and a telephone number of a party to be called by the recipient;

verifying the electronic certificate using the unique identifier to locate the information stored in the database; and

sending a call request message to a call control node, which is a virtual switching node in a switched telephone network, to instruct the call control node to initiate actions in the switched telephone network to establish a telephone connection between the calling telephone number and the called telephone number.

Preferably, messages exchanged via the data network between the recipient's computer and the application server when the icon is activated are encrypted.

The application server preferably comprises programmed instructions for encrypting and decrypting at least part of all messages sent and received.

The apparatus further comprises a call control node adapted to communicate with the application server and with switching nodes in a switched telephone network. The call control node is preferably a virtual switching node adapted to function as a node in a common channel signaling network and further adapted to formulate and send common channel signaling messages to control calls between the recipient and a called party.

The invention further provides an apparatus for providing electronically mailable call credits, comprising:

an application server adapted to be connected to a data network;

a memory device associated with the application server for storing information in a database;

programmed instructions on the application server for accepting from a customer a purchase order of a specified purchase value of call credits via the data network;

programmed instructions on the application server for issuing an electronic certificate for the value of the call credits purchased;

programmed instructions on the application server for storing information related to the electronic certificate in the database; and

programmed instructions for sending a copy of the electronic certificate via email to a recipient designated by the customer, the electronic certificate including at least the value of the call credits purchased and a unique identifier for retrieving the stored information related to the electronic certificate.

The invention therefore provides a simple, fast and convenient way for customers to purchase call credits for designated recipients. The customer may configure the electronic certificate as desired using a plurality of options and may designate the calling party number and optionally the called party number when purchasing a call credit certificate. The method of using the call credits to initiate a call is convenient and secure. The unique identifier of the electronic certificate for the call credits is verified before forwarding a call request to the call control node. To minimize the possibility of fraud, the encrypted unique identifier that is transmitted from the call certificate to the application server is not revealed to the customer or the recipient. Consequently, only persons having access to the recipients email account can activate a call request using an electronic certificate sent to the recipient.

The invention may be used for providing general long distance calling services. It may also be used for the purchase of call credits for occasional long distance use rather than subscribing to a particular long distance service plan or provider.

### BRIEF DESCRIPTION OF THE DRAWINGS

The invention will now be explained by way of example only and with reference to the accompanying drawings, in which:

FIG. 1 is a schematic diagram of a portion of a switched telephone network equipped with an apparatus for providing electronically mailable call credits in accordance with the present invention;

FIGS. 2 and 3 are schematic diagrams of screen displays showing exemplary options for the purchase of electronically mailable call credits;

FIG. 4 is a schematic view of a screen display showing an exemplary gift certificate created using the apparatus in accordance with the invention;

FIGS. 5A and 5B illustrate a flow diagram illustrating a procedure followed by a customer purchasing call credits using the apparatus shown in FIG. 1;

FIG. 6 is a flow diagram illustrating a procedure followed by a recipient of a call credit certificate when requesting a telephone call to be charged to the electronic certificate;

FIG. 7 is a flow diagram illustrating a procedure executed by an application server processing a telephone call requested by a recipient which is charged to an electronic certificate;

FIG. 8 is a call flow diagram showing principal call control messages exchanged in a setup and release of a call in accordance with the invention using interswitch EISUP trunks; and

FIG. 9 is a call flow diagram showing principal call control messages exchanged in a setup and release of a call in accordance with the invention using loop-back EISUP trunks.

### DETAILED DESCRIPTION OF THE PREFERRED EMBODIMENT

The invention relates to a method and apparatus for vending electronic call credits which may be emailed to a recipient and to a method and apparatus for completing call connections directly from an emailed electronic certificate for the call credits.

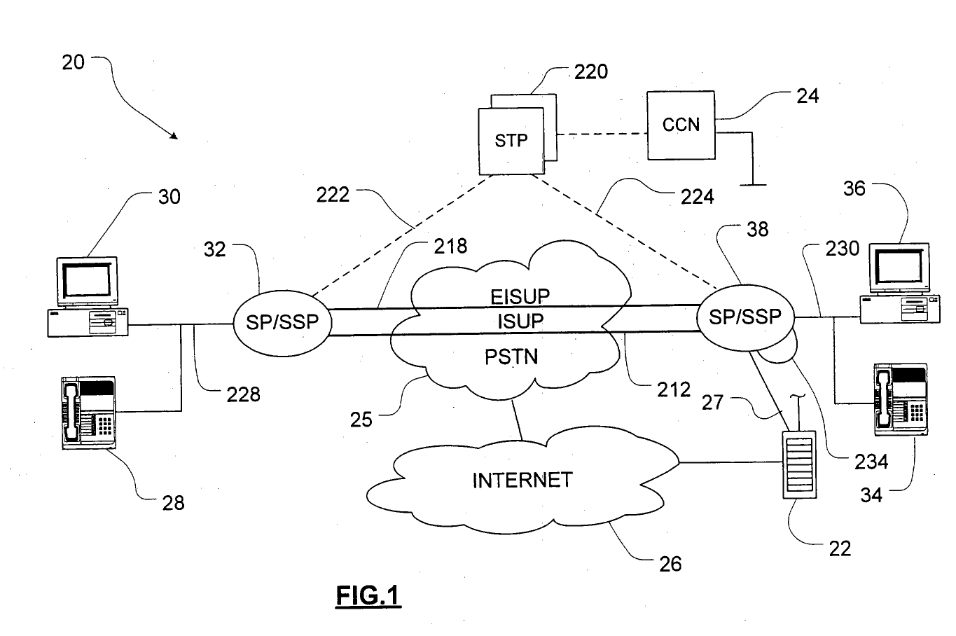

FIG. 1 is a schematic diagram of a portion of a communications network equipped with an apparatus for issuing and using electronically mailable call credits in accordance with the invention. The apparatus generally indicated by reference numeral 20, is shown in relation to a portion of a public switched telephone network (PSTN) 25 and the Internet 26. The apparatus 20 includes at least one application server 22 and a call control node (CCN) 24 which is a virtual switching node in the PSTN 25 and a physical node in an associated common channel signaling network. The application server 22 is World Wide Web accessible through the Internet 26. The application server 22 includes programmed instructions for permitting customers to purchase electronic certificates for pre-paid call credits that may be used for completing calls in the PSTN 25. Each electronic certificate issued includes at least the purchased value of the call credits, a unique identifier and an email address of a designated recipient of the electronic certificate.

The application server 22 further has access to a memory for storing a database and programmed instructions for storing a copy of each certificate in a database and sending the electronic certificate to the recipient via email. The application server 22 is preferably enabled to encrypt and decrypt messages sent and received. It is also enabled to calculate costs of call sessions and deduct a charge for a call made using an electronic certificate. When a call is made, the application server deducts a charge for the call from a stored remaining value of call credits associated with the electronic certificate. The application server 22 is also preferably provided access to a database of designs which may be displayed to the customer to permit the customer to use a point and click interface to create a message or a greeting card to accompany the electronic certificate.

The CCN 24 is a node in a Common Channel Signaling (SS7) network and is adapted to formulate and send common channel signaling messages to control calls initiated by the recipient. A detailed description of the architecture of the CCN 24, referred to as a virtual switching point (VSP), is provided in Applicant's U.S. Pat. No. 6,226,289, entitled METHOD AND APPARATUS FOR DYNAMICALLY ROUTING CALLS IN AN INTELLIGENT NETWORK, the specification of which is incorporated herein by reference.

The CCN 24 has a common channel signaling interface for sending and receiving common channel signaling messages. It further includes programmed instructions for examining common channel signaling messages and transparently passing selected common channel signaling messages to other signaling nodes in the network, and programmed instructions for formulating common channel signaling messages in response to predetermined criteria. The CCN 24 further includes a data network interface for sending and receiving data messages and instructions for tracking individual call sessions virtually switched therethrough. The CCN 24 has a memory for storing messages received from or sent to the application server 22.

As is well known in the art, the public switched telephone network (PSTN) 25 includes a plurality of telephone switches commonly referred to as Service Switching Points (SSPs). The application server 22 is connected to an SSP 38 by a trunk group 27 which logically terminates on the CCN 24 but physically terminates on the application server 22. Each SSP in the network serves a plurality of subscribers. The subscribers own telephones 28, 34 which are connected to the respective SSPs 32, 38 by customer service lines, as is well known in the art. Many subscribers also own Personal Computers (PCs) 30, 36 which may be connected to the Internet 26 or some other data network using the subscriber lines in a manner well known in the art.

The Internet 26 supports the World Wide Web which enables electronic commerce in a manner known in the art. A user of the PC 30 may access the World Wide Web through a dial-up or dedicated connection to an Internet Service Provider (ISP). The user may use the PC 30 to access a Web page of application server 22 which is configured to vend electronic call credits in a variety of formats and options, as will be described below in more detail. If the user elects to purchase an electronic call certificate, the user becomes a customer. The customer designates a recipient of the electronic certificate. The recipient may be the customer or any other person having an email address. After a purchase is confirmed, the application server 22 issues an electronic certificate for the purchased value of the call credits. Each electronic certificate is associated with a unique identifier. The electronic certificate is sent via email to the recipient's email address and a copy of the electronic certificate information is stored in the database of the application server 22.

When the recipient logs on to their email account and opens the message that includes an electronic certificate, the recipient may use the electronic certificate to request a telephone call by activating a call icon in the electronic certificate. The electronic certificate is preferably associated with the email message as an attachment and it can consequently be dragged and dropped onto the desktop, for example, for easy accessibility. Clicking on the call icon will initiate a call by displaying a call request form. The format of the call request form depends on several factors, as will be explained below in more detail. For example, the customer has an option to specify the called number for an electronic certificate. If the electronic certificate is a “Call Me” certificate, the customer predetermines the called number and it cannot be modified by the recipient.

In any event, the call request form includes a telephone number from which the call is to originate and a telephone number of the party to be called, which may or may not be modifiable, as explained above. After the recipient has approved the modifiable telephone number(s) on the form, the recipient may select a “Place Call” button to proceed with the call. If the recipient's PC 30 is not logged on to the Internet, a log-on window is displayed, in a manner well known in the art. After a connection to the Internet 26 is established, the call request is forwarded by the electronic certificate to a certificate redemption server which may be implemented on the same platform as the application server 22, or on an independent server (not shown). The certificate redemption server verifies the call request form and sends a call request message to the CCN 24. The CCN 24 establishes a telephone connection between the originating telephone number and the called telephone number. The details of the procedures for purchasing the electronic certificate, requesting a telephone call and establishing the connection will be described below in more detail.

Certificate Purchase

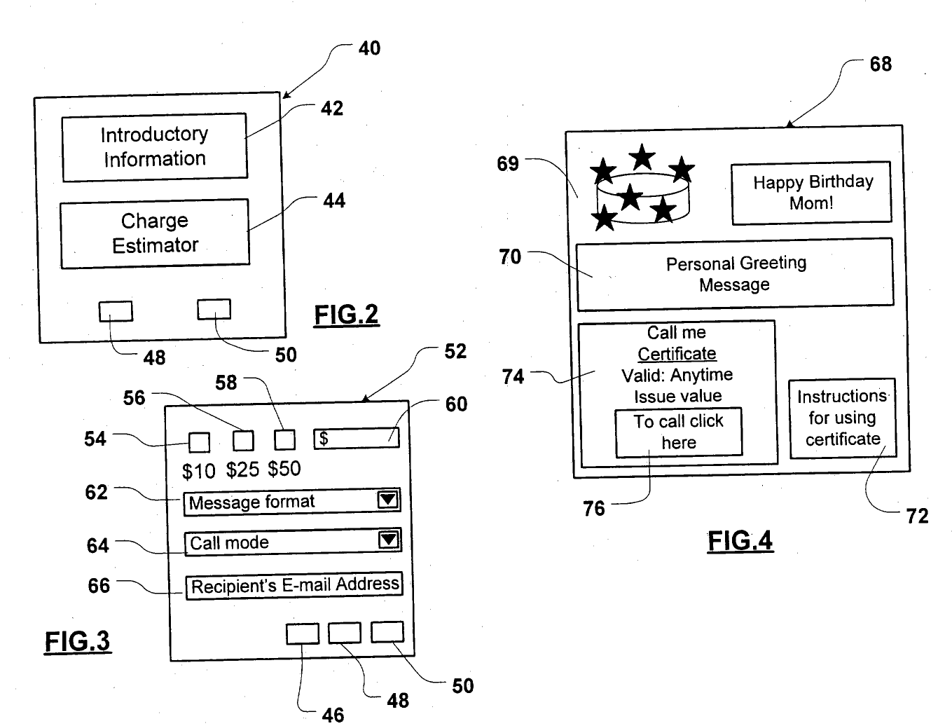

When a potential customer accesses the home page of the application server 22, a service menu is displayed on the screen of the PC 30 which guides the customer through a purchasing procedure while presenting options that permit the customer to select an electronic certificate to meet their needs and/or their budget. A few examples of selections displayed are schematically illustrated in FIGS. 2 and 3. A display 40, as shown in FIG. 2, includes introductory information section 42 that provides information about the purchase of electronically mailable call credits. The information section 42 may also include news items about current specials and other promotional material. A call charge estimator is also preferably provided. The charge estimator 44 permits a customer to input an originating telephone number or an originating city name and a terminating telephone number or city name, a time of day and a day of the week to determine cost per minute of a call. A specific call duration, 20 minutes for example, may also be specified to determine a charge for a specific call. The web page 40 also includes two function buttons, a “Next” button 48 to continue and “Cancel” button 50 to permit the customer to cancel the purchase procedure.

A next page 52 is schematically shown in FIG. 3 when the customer selects the “Next” button 48 from page 40, the second page 52 is displayed. The second page 52 includes, for example, three radio buttons 54, 56 and 58, that permits the customer to select a predefined purchase value of $10, $25 and $50, respectively. A numeric field 60 permits the customer to input another value. If the customer requested an estimate for a specific call as described above, the last requested estimate may be displayed as a default in the numeric field 60. Programmed logic in the electronic certificate prevents two different amounts from being concurrently selected.

Drop-down menus 62, 64 are provided to permit the customer to select a message format and a call mode for the electronic certificate. The message format menu will, for example, display a plurality of options for an email message used to deliver the electronic certificate. The options may include, for example, “None” for a customer who purchases an electronic certificate for personal use; “email” message for a customer who wishes to send a simple message to the recipient; “Occasion Card” for a customer who wishes to purchase an electronic certificate for a special occasion; or “Thank You Note” for a customer who wishes to purchase an electronic certificate as a thank you gift. The menu selection may, of course, be seasonal. For example, Christmas, Hanukah, Rhamadan, Valentines Day, Easter, Passover or Thanksgiving cards may be provided as options at an appropriate time of the year. A call mode section menu 64 is also provided to permit the customer to select a call mode for the electronic certificate. The customer may select one of at least three call modes including “Call Me”, “Call a Specified Party” and “Call Anyone”. If the “Call Me” option is selected, the customer inputs their own telephone number and the number cannot be modified by the recipient. Consequently, the electronic certificate can only be used to call the customer. If the option to Call a Specified Party is selected, the customer inputs a telephone number of a party to be called by the recipient and the recipient may only use the electronic certificate to call the party specified by the customer. If the Call Anyone option is selected, the customer does not specify a number to be called and the recipient may use the electronic certificate to call any party. Further options may be presented to restart, select a time of day or day of the week for use of the electronic certificate, etc.

A recipient's email address section 66 enables the customer to input the recipient's email address to which the electronic certificate is to be delivered. Optionally, the customer may be able to insert another variable which may be used to retrieve an email address, such as a telephone number, or the like. Navigational buttons “Go Back” 46, “Next” 48 and “Cancel” 50 permit the customer to move back to the previous page, move on to the next page or cancel the purchase transaction, respectively.

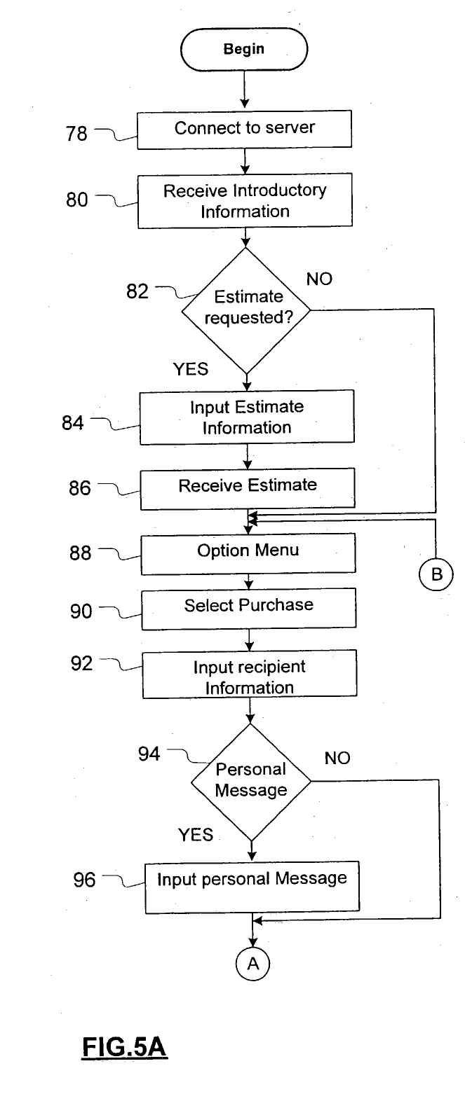

FIG. 4 illustrates an example of a customer interface used to create a customer occasion card. In the example shown, the customer has created a card in which an electronic copy of an electronic certificate 68 is incorporated into a birthday card. The customer interface 68 includes section 70 where the customer is permitted to input a personalized greeting message to the recipient. In an area 69 above the message, the customer is enabled to select from a palette of graphic images and text fonts to create a personalized occasion card. Alternatively, the customer may select a favourite from a library of pre-constructed designs for different types of cards. Preferably, a small information window 72 provides the recipient with instructions for using the electronic certificate 74. The electronic certificate 74 displayed at the bottom of the card shows the type of certificate, a purchased value of the call credits and preferably also indicates when the electronic certificate can be used. A call icon 76 located on a button of the electronic certificate 74 permits the recipient to initiate a call request with a mouse click.

The user interface may also be designed to permit customers to incorporate other features. In addition to, or instead of, a text message, an audible greeting, for example, may be recorded by a customer with a multi-media PC. Alternatively, the user interface may include a library of pre-recorded music selections which may be attached to a card so that when the recipient opens the email, the audible greeting message or the music is played.

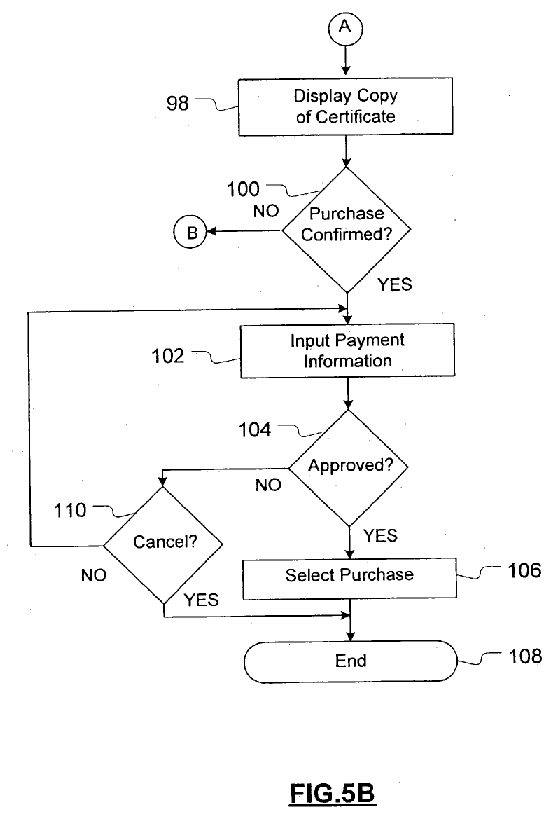

FIGS. 5A and 5B illustrate a flow chart that summarizes a procedure a customer follows to purchase an electronic certificate. The customer begins the purchase procedure by accessing the application server 22 through the Internet 26 using the PC 30, as indicated in FIG. 5A step 78. In step 80, the customer receives introductory information about the purchase. The introductory information is included in the screen display 40 (FIG. 2). The charge estimator 44 is also provided in the screen display 40 and the customer decides whether to have an estimate of a cost for telephone calls between two specified locations, as indicated by the decision block 82. The customer moves to step 88 and receives an option menu if an estimate is not desired and the “Next” button 48 is selected. Otherwise, the customer enters call estimate information to the charge estimator page 44, in step 84. If a call estimate is selected, the customer receives the estimate in step 86, that assists the customer in selecting an appropriate purchase value for call credits. In step 88, the customer receives an option menu, as illustrated in FIG. 3, from which the customer is able to select a predetermined purchase value of $10, $25 or $50, for example, or to input any other desired amount in the purchase value box 60.

The customer uses the message format menu to select a format for a message to accompany the certificate. The message format menu offers selections such as: no message; occasion card; thank you note; etc. The customer also selects a call mode from the call mode menu 64. The call node menu may include selections for “Call Me”, “Call a Particular Person” or “Call Anyone”, as described above. The customer is requested to input their telephone number if the “Call Me” option is selected. The customer must also input a telephone number if the “Call a Particular Person” option is selected. This option may permit the input of two or more telephone numbers to permit any one of service persons to be phoned. Those inputs are accomplished in step 90. In step 92, the customer inputs the recipient's email address in section 66 (FIG. 3), to which the call credit certificate will be sent via email. The message format 64 (FIG. 3) is examined in step 94 to determine whether a personalized message is required to appear on the certificate. If the message format does not require a personal message, a copy of the certificate is displayed to the customer in step 98 (FIG. 5B). Otherwise, the personalized message is input in step 96 and a copy of the certificate is displayed to the customer in step 98. The personalized message appears in the copy of the certificate (see FIG. 4).

After the completed certificate is displayed, the customer must confirm the purchase. If a purchase is not confirmed, the screen display is returned to the option menu (step 88) to permit the customer to change the purchase order. If the purchase is confirmed, the customer must input payment information, which includes selecting one of a credit card, debit card and calling card, and inputting a card number and card expiration date, for example. On receipt of the payment information, the application server 22 (FIG. 1) sends a query message to the issuing credit authority for approval for the purchase, in a manner well known in the art. If the payment is not approved step 104, the customer must indicate in step 110 whether to cancel the transaction or return to step 102 to re-input payment information. If the payment is approved, the customer is issued a receipt (step 106) and the transaction is completed (108). The receipt may be stored in the customer's PC 30 or printed to serve as evidence of the purchase. In step 108, completion of the transaction involves several steps in which the customer is not involved. For example, a copy of information defining the certificate is stored in a database. The database may be associated with the application server 22 (FIG. 1) or with the separate certificate redemption server (not shown). Thereafter, the certificate is emailed to the recipient address and the date and time of mailing is recorded in the database. If the certificate is returned because the email address is invalid, the purchase price is credited to the customer's account and a notice is sent to the customer by email if customer contact information is available.

Certificate Redemption

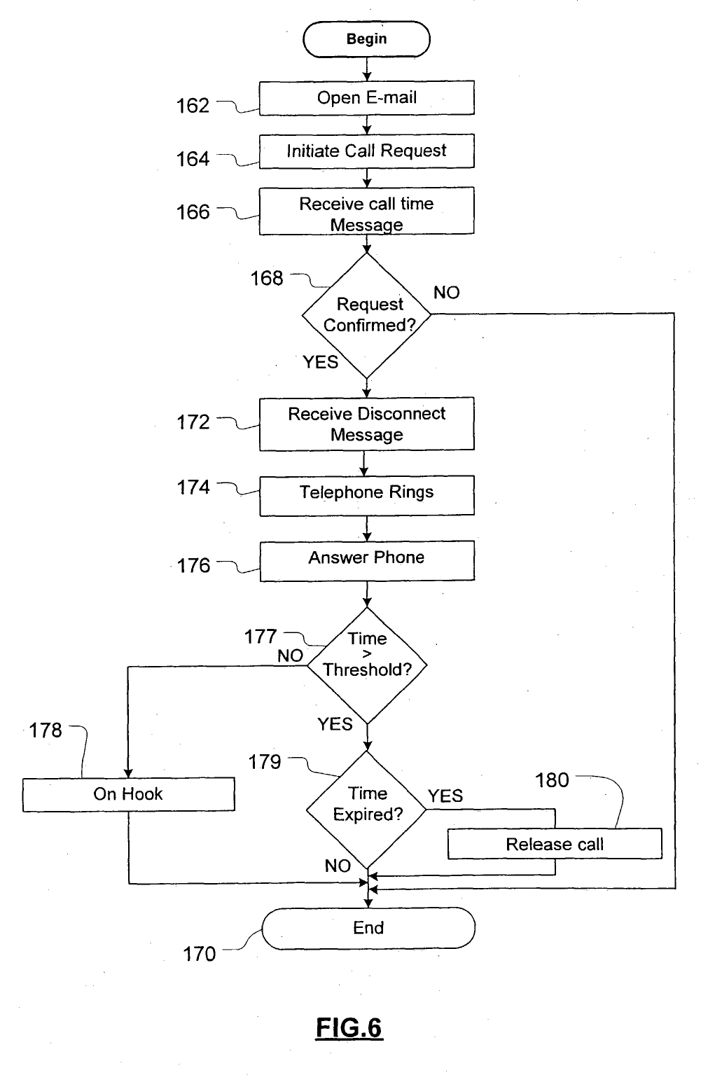

FIG. 6 illustrates the steps involved in the redemption of a call credit certificate by requesting a call completion. The recipient opens their email box from the PC 36 (step 162) and opens the certificate (FIG. 4) as any other email message is opened. The personalized greeting message, if any, and information for using the certificate is displayed. The specified call mode selected by the customer is also displayed. To request a call, the recipient (step 164) clicks on the icon 76 to activate it. When activated, the icon displays an appropriate call initiation input form which may require the recipient to input their telephone number as well as a called party number, if the call mode is “Call Anyone”. The recipient is not requested to input a called party number if the call mode is “Call Me”. If the call mode is “Call a Particular Person”, the recipient may be required to select a number from a list entered by the customer. After the call initiation input form is completed, it is sent to the application server 22.

In step 166, the application server 22 may analyze the information and display a maximum call time message on the screen of PC 36. The maximum call time message may include a call history, if any previous calls were made using the certificate, and a maximum call duration available in accordance with a value of call credits that remain in the electronic certificate giving the calling and called numbers. The recipient must then confirm the call request in step 168. The recipient can terminate the request, as indicated in step 170, if the maximum call duration available is too short, or for some other reason. However, the application server 22 may also terminate the request because the maximum call duration available is less than a reasonable duration threshold for the call. Regardless of the cause of termination, the recipient is able to restart the procedure to place a call to another party if the call mode is “Call Anyone” or “Call a Particular Person” and more than one called number is specified. For example, the recipient may abandon a call to Japan and try again to use the certificate to call someone in North America, for example. If the call request is confirmed, the recipient will receive a Disconnect message, in step 172, on the screen of the PC 36. The Disconnect message advises the recipient to Disconnect the PC 36 from the telephone line to free the telephone line for telephone 34, if the PC 36 shares the telephone line with the telephone 34, or simply to ensure that the telephone 34 is ready for incoming calls. The recipient answers the telephone in step 176 when the telephone 34 rings in step 174 and goes on-hook to complete the call, as indicated in step 179 if the call is completed before the call credits are exhausted. However, if the call duration exceeds a time threshold determined by the remaining call credits (step 178), as computed by the CCN 24, the CCN 24 will terminate the call by sending Release messages in each direction through the signaling network to cause the call facilities to be released in step 180.

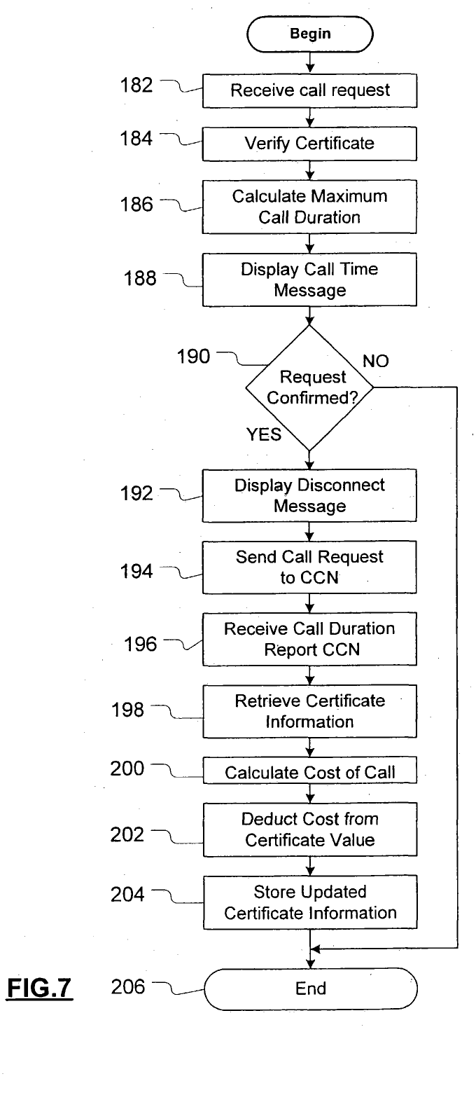

FIG. 7 illustrates the steps of a procedure performed by the application server 22 in response to the recipient's call request initiating the telephone call charged to a call credit certificate. As noted above, the call credit redemption procedure may be performed by the application server 22 or by a call credit redemption server (not illustrated). In this example, the procedure is performed by the application server 22. The application server 22, in step 182, receives the call request from the call credit certificate recipient. The call request includes the information respecting the calling and called party numbers and the unique identifier, as described above. The unique identifier is encrypted and associated on issuance with the call credit certificate by the application server 22, as explained above. The unique identifier is not displayed to the recipient, but is inserted in the call request by program code such as a Java script when the icon is activated.

On receipt of a call request message, the application server 22, in step 184, verifies the call request by accessing the certificate information stored in the database using the unique identifier inserted in the call request message and, in step 186, calculates a maximum call duration using the calling and called party numbers and a call rate database. The result of the call duration calculation is preferably displayed on the recipient's PC 36 along with a previous call history, as indicated in step 188. On receipt of the call duration message, the recipient confirms the call request in step 190. If the computed call duration is less than a minimum threshold, the application server 22 may deny the request and the call is cancelled in step 206. The application server 22 displays the Disconnect message to the recipient, as indicated in step 192, and sends a message through the Internet 26 to the CCN 24 to instruct the CCN 24 to initiate actions in the PSTN to connect the recipient's telephone to the called party telephone, as indicated in step 194, if the call request is confirmed by the recipient and the computed call duration exceeds the threshold. The message sent to CCN 24 includes telephone numbers of the calling and called parties, maximum call duration and the unique identifier to permit the CCN 24 to return an actual call duration report.

The actual call duration report) from the CCN is received at the application server 22, in step 196, after the telephone communication between the calling and called parties is completed or terminated by the CCN 24, if the maximum call duration is exceeded. The application server 22 uses the unique identifier associated with the report to retrieve the electronic certificate information from the database, in step 198 and calculates, in step 200, the actual call cost using the certificate information. The message to the CCN 24 and the report to the application server 22 are respectively encrypted. The cost of the call is deducted from the remaining value of the certificate and the resultant value of the call credits is stored in the database as updated certificate information in steps 202 and 204.

The CCN 24 performs the signaling required to connect the call certificate recipient to a called party. The CCN 24 is a physical node in the common channel signaling network (SS7) of a public switched telephone network (PSTN). To further illustrate the procedure of setting up and controlling a telephone call between the recipient and a called party initiated by a call request to the application server 22, two examples are described below.

Network Control During Certificate Redemption

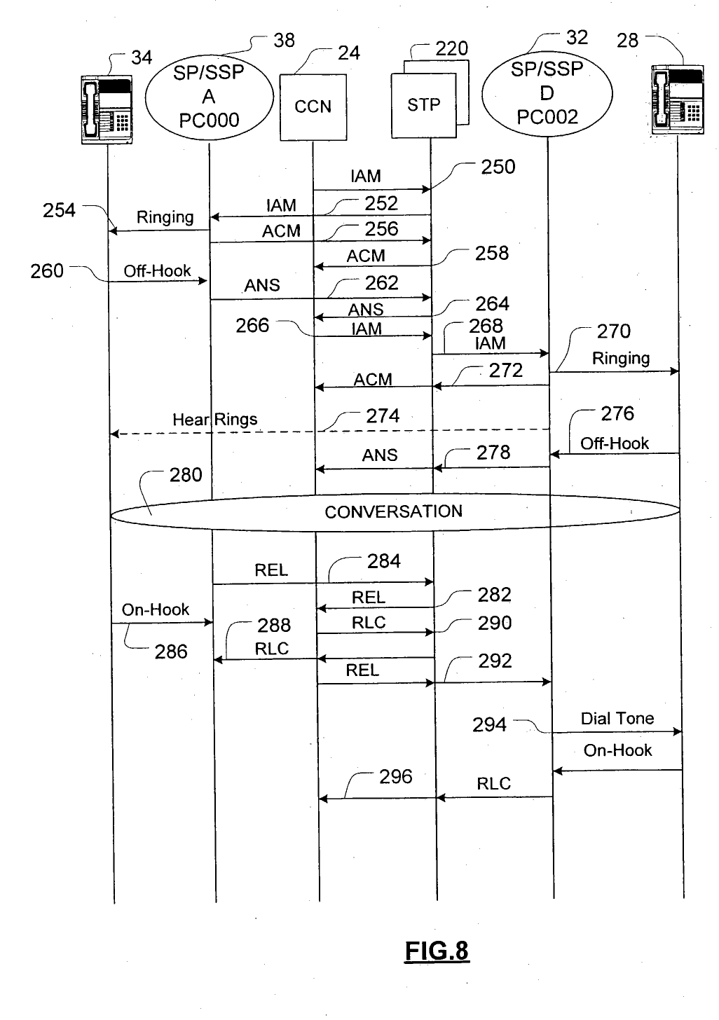

FIG. 8 illustrates a call flow diagram in which the calling party is the recipient of a call credit certificate and the called party is, for example, the customer who purchased a “Call Me” certificate. The customer's telephone 28 and the PC 30 are connected to the SSP 32 by a subscriber line 210 (FIG. 1). In order to enable the invention to be practiced, selected SSPs in the network are equipped with EISUP trunks which are designated for handling selected calls. The EISUP trunks 218 are preferably ISUP trunk groups carried on DS1 or E1 facilities that respectively accommodate 24 or 30 voice channels. EISUP trunks are differentiated from other ISUP trunks in the network in that the CCN 24 is a virtual switching node associated with each EISUP trunk group. To other switching points in the network, the CCN 24 appears to be a physical switching node in a middle of each EISUP trunk group. Each voice channel is referred to as a trunk member.

The CCN 24 is connected to the common channel signaling network, for example, by a signal transfer point (STP) pair 220 using SS7 A-links 222. The STP pair 220 is connected to SSPs 32 and 38 using A-links 224. Since the CCN 24 serves as a virtual switching node in a call path routed over an EISUP trunk, it is enabled to assume control of a call by treating connections in the call path as controllable connections which may be released or reconnected as required using ISUP signaling messages which it generates, manipulates or modifies, as required.

As shown in FIG. 8, a call control messaging sequence is initiated when the CCN 24 receives a call request from the application server 22 in a PSTN in which the call is routed over interswitch EISUP trunks. Interswitch EISUP trunks are described in detail in Applicant's patent referred to above. When the CCN 24 receives a call request from the application server 22, the CCN 24 extracts the calling (recipient) and called party numbers from the message and first uses the calling party number to formulate an Initial Address Message (IAM) to initiate a call to the called party. The CCN 24 sends the IAM message 250 via SS7 A-links 222 to the STP pair 220. The STP pair 222 forwards the IAM message 252 to the SSP 38. On receipt of the IAM, the SSP 38 verifies that the subscriber line 230 is idle and sets rings 254 on the subscriber line 230 to the telephone 34.

Meanwhile, the SSP 38 formulates an Address Complete (ACM) message 256 and sends it via the SS7 A-link 224 to the STP pair 220. The STP pair 220 in turn forwards the ACM message 258 via the SS7 A-links 222 to the CCN 24. When an off-hook signal 260 is detected on subscriber line 230, the SSP 38 formulates an Answer (ANM) message 264 and sends it to the CCN 24 through the SS7 A-links 224 and 222 via the STP pair 220 (message 262). On receipt of the ANM message (264), the CCN 24 has confirmation message 264 that the recipient is on the line. The CCN 24 therefore formulates a second IAM message 266 containing the called party number and sends it via the SS7 A-link 222 to the STP 220 that in turn passes the IAM message 268 via the SS7 A-link 224 to the SSP 32 which serves the subscriber line 228 of the called party. The SSP 32 responds to the IAM 268 by verifying that the subscriber line 230 is idle and applies rings 270 to the line. The first and second IAMs are interrelated to an extent that circuit identification codes (CICs) in each message identify opposite ends of the same trunk member in EISUP 210 (FIG. 1). The SSP 32 then formulates an ACM message 272 and sends it to the CCN 24 through the SS7 A-links 224 and 222 via the STP pair 220.

Telephone 34 is now connected to telephone 28 by the selected CIC of the EISUP trunk group 218. Therefore, the recipient hears the rings 274 applied to telephone 28. When the called party answers 276 telephone 28, the SSP 32 detects an off-hook signal and formulates an Answer (ANM) message 278 which it sends to the CCN 24 via the SS7 A-links 224 and 222 via the STP pair 220. The call setup is now completed and conversation 280 between the two parties begins.

If the call is not terminated by the CCN 24 because the maximum call duration is exceeded, the CCN 24 detects call termination when the SSP 38 formulates a Release (REL) message 282 and sends this message through the SS7 A-links 224 and 222 to the CCN 24 via the STP pair 220 284 in response to the calling party going on-hook 286. Upon receipt of the REL message 282 from the SSP 38, the CCN 24 formulates an RLC message 288 and sends it (message 290) via STP pair 220 to the SSP 38. Meanwhile, the CCN 24 also formulates an REL message 292 and sends it via the STP pair 220 to the SSP 32. The SSP 32 in turn applies dial tone 294 to the subscriber line 228 and formulates an RLC message 296 and sends it over the SS7 A-links 224, 222 to the CCN 24 via the STP pair 220. The call connection is thus terminated. On call termination, the CCN sends a call duration report to the application server 22 via the Internet 26 to permit the application server to update the call credit certificate record, as explained above.

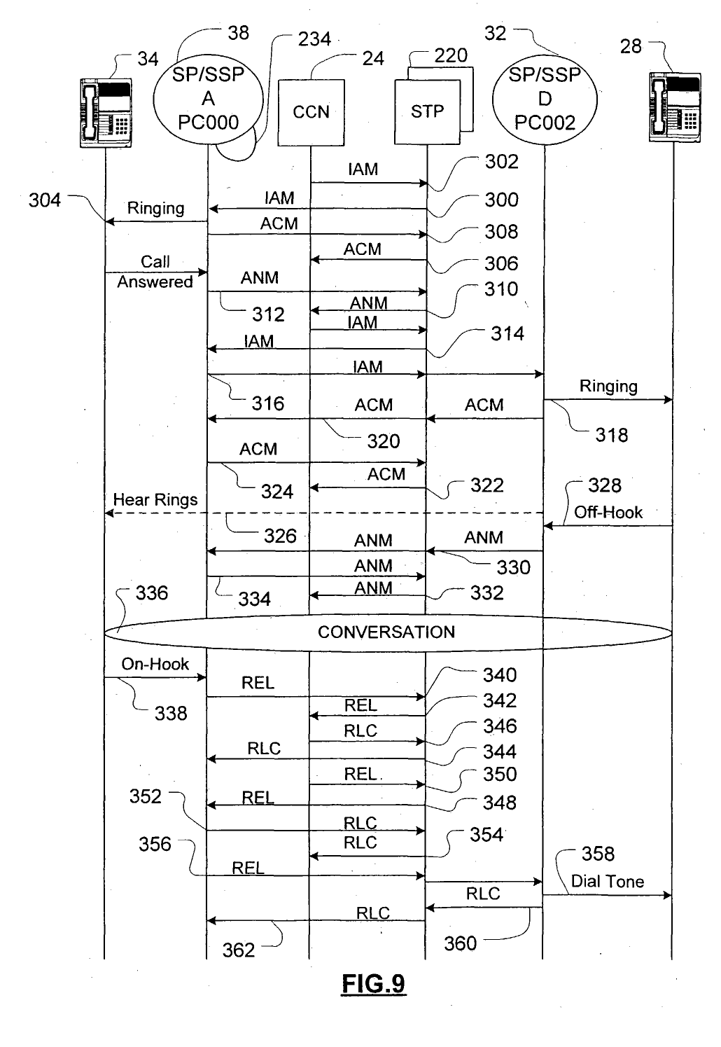

FIG. 9 illustrates the principal call control messages exchanged when a call is completed using loop-back EISUP trunks 234. The CCN 24 sends the IAM message 300 through the SS7 A-links 222, 224 via (302) the STP pair 220 to the SSP 38. Because loop-back trunks 234 are used at the SSP 38, the IAM message 300 is directed to an end of the loop-back group trunk 234 provisioned for inbound calls. On receipt of the IAM, the SSP 38 treats the call as any other inbound call and applies ringing signals 304 to the subscriber line 230, which causes the telephone 34 to ring. The SSP 38 then formulates an ACM message 306 and forwards the message over (308) the SS7 A-links 224, 222 via the STP pair 220 to the CCN 24. The SSP 38 also formulates an ANM message when the call certificate recipient answers the telephone 34, and forwards the ANM message 310 to the CCN 24 via (312) the STP pair 220.

After CCN 24 receives the ANM message 310, the CCN 24 formulates another IAM message 314, in which the called number is the called party's number. The second IAM contains a CIC which points to an outbound end of the same trunk member of the loop-back trunk group 234 referenced in the first IAM 300. On receipt of the IAM, the SSP 38 consults its routing tables to determine where the IAM should be routed. The translation tables point to the SSP 32, so the IAM message 316 is forwarded to the SSP 32. On receipt of the IAM 316, the SP 32 checks the availability of the called party line and applies ringing signals 318 to the line 228. The SSP 32 then formulates an ACM message 320 and sends the ACM back to the SSP 38. The SSP 38 in turn relays the ACM message 322, 324 to the CCN 24. At this point in the call setup process, the telephones 34 and 28 are connected by an available member of the ISUP trunk groups 212 and the EISUP loop-back trunks 234 and the recipient hears the ringing signals 326 applied to the telephone 28. The SSP 32 generates an ANM message 330 when an off-hook signal 328 is detected on the subscriber line 228. The SSP 38 sends the ANM message to the STP 220. The STP 220 38 forwards the ANM message 332 through to the CCN 24. Call setup is thus completed and the conversation 330 begins.

If the call is not terminated by the CCN 24 because the maximum call duration has been exceeded, the call will terminate normally when one of the parties places their telephone on-hook. In this example, the SSP 38 detects an on-hook signal 338 and generates an REL message 340 when the recipient hangs up the telephone 34 and sends REL message 342 to the CCN 24. The CCN 24 receives the REL message 342 and stops a timer associated with the call. The CCN 24 then formulates an RLC message 344 and sends the RLC message 344 to the SSP 38 via the RLC message 346 to the STP pair 220. Subsequently, the CCN 24 formulates another REL message 348, 350 and sends that message to the SSP 32 which releases the outbound end of the loop-back trunk member of trunk group 234, and forwards the REL message 348 to the SSP 38. The SSP 38 subsequently generates an RLC message 356 to the SSP 32. On receipt of the REL message 356, the SSP 32 releases facilities seized to handle the call and sets a dial tone 358 on the subscriber line 228. The SSP 32 forwards the RLC message 360 to the STP 220 and the STP sends message 362 to the SSP 38. Call processing is thus completed and the CCN 24 formulates a data message to report the duration of the call to the application server 22. The CCN 24 sends the data message to the application server 22 over the Internet. The application server 22 uses the unique identifier included in the message to retrieve the call certificate record. The application server 22 computes a charge for the call using the call duration and deducts the charge from the call credits. The application 22 then updates a call record by including particulars of the call just completed and saves the updated call certificate to the database.

As will be understood by persons skilled in the art, the recipient may be the customer who purchased the call credits. Consequently, the methods and apparatus in accordance with the invention enable the purchase of call credits for long distance services on an as required basis.

The embodiments of the invention described above are intended to be exemplary only, the scope of the invention being limited solely by the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. An apparatus for providing electronically mailable call credits, comprising:
an application server adapted to be connected to a data network;
a memory associated with the application server for storing information in a database;
programmed instructions on the application server for accepting from a customer a purchase order of a specified purchase value of call credits via the data network;
programmed instructions on the application server for issuing an electronic call certificate for the value of the call credits purchased;
programmed instructions on the application server for storing information related to the electronic call certificate in the database; and
programmed instructions for sending a copy of the electronic call certificate via email to a recipient designated by the customer, the electronic call certificate including at least the value of the call credits purchased and a unique identifier for retrieving the stored information related to the electronic call certificate.

20. An apparatus as claimed in claim 19 wherein the application server comprises programmed instructions for encrypting and decrypting at least part of the messages sent and received.

21. An apparatus as claimed in claim 19 wherein the programmed instructions for accepting the purchase order are adapted to accept a payment from the customer for the purchase order by one of a credit card, debit card and calling card.

22. An apparatus as claimed in claim 21 wherein the programmed instructions for accepting the purchase order are adapted to communicate via the data network with a financial institution which issued the credit card, debit card or calling card to obtain an authorization for the purchase order.

23. An apparatus as claimed in claim 19 further comprising a call control node adapted to communicate with the application server and to communicate with switching nodes in a switched telephone network.

24. An apparatus as claimed in claim 23 wherein the call control node is a virtual switching point adapted to function as a node in a common channel signaling network and further adapted to formulate and send common channel signaling messages to control a call connection between the recipient and the called party.

25. An apparatus as claimed in claim 24 wherein the call control node comprises:
a common channel signaling interface for sending and receiving common channel signaling messages;
programmed instructions for examining common channel signaling messages and transparently passing selected common channel signaling messages to an adjacent signaling node;
programmed instructions for formulating common channel signaling messages in response to predetermined criteria;
a data network interface for sending and receiving data messages; and
programmed instructions for tracking individual call sessions virtually switched therethrough.

26. An apparatus as claimed in claim 25 wherein the call control node is adapted to report a duration of a call associated with the unique identifier to the computer application server.

27. An apparatus as claimed in claim 26 wherein the application server comprises programmed instructions for calculating a charge for a call session.

28. An apparatus as claimed in claim 27 wherein the application server comprises programmed instructions for deducting a charge for a call connection from a stored remaining value of call credits associated with an electronic call certificate.

29. An apparatus as claimed in claim 25 wherein the call control node is adapted to receive from the application server information respecting a maximum call duration and is further adapted to terminate the call connection when the maximum call duration has expired.

30. An apparatus as claimed in claim 23 wherein the call control node further comprises:
a memory for storing at least one of the common channel signaling messages; and
a memory for storing messages received from and to be sent via the data network to the application server.

31. An apparatus as claimed in claim 23 wherein the call control node further comprises programmed instructions for encrypting and decrypting messages sent to and received from the application server.

32. An apparatus as claimed in claim 19 wherein the application server has access to a database of designs which are displayed on demand to the customer, the customer being enabled to create a message or a greeting card into which the electronic certificate is incorporated.
